(19) United States
(12) Patent Application Publication
(10) Pub. No.: US 2015/0047754 A1
(43) Pub. Date: Feb. 19, 2015

(54) Cr-Mo ALLOY STEEL COMPOSITION HAVING EXCELLENT HYDROGEN BRITTLENESS RESISTANCE AND METHOD FOR HEAT TREATMENT OF THE SAME

(71) Applicant: Hyundai Motor Company, Seoul (KR)

(72) Inventor: Ho-Seung Lee, Whasung-Si (KR)

(73) Assignee: Hyundai Motor Company, Seoul (KR)

(21) Appl. No.: 14/137,066

(22) Filed: Dec. 20, 2013

(30) Foreign Application Priority Data
Aug. 13, 2013 (KR) 10-2013-0095844

(51) Int. Cl. C21D 1/28; C21D 6/00; C22C 38/22; F17C 1/14; C22C 38/06; C22C 38/04; C22C 38/02; C21D 8/00; C22C 38/20

(52) U.S. Cl. CPC C21D 1/28; C21D 8/005; C21D 6/002; C21D 6/005; C21D 6/008; C22C 38/22; C22C 38/20; C22C 38/06; C22C 38/04; C22C 38/02; F17C 1/14
USPC 148/547; 420/90

(57) ABSTRACT

Alloy steel compositions having improved resistance to hydrogen brittleness and methods of heat treating same are provided. The alloy steel compositions find applications in hydrogen storage containers, piping systems for hydrogen fuel cell vehicles, or reinforced boards for sound absorption/insulation on a multiple layers. The alloy steel compositions include 1.0 to 2.5% by weight of aluminum (Al), based on the total weight of the composition. Improved resistance to hydrogen brittleness is effected by stabilizing an inner part of the composition and forming an Al₂O₃ layer on a surface of the composition.

### CROSS-REFERENCE TO RELATED APPLICATION

The present application claims priority to Korean Patent Application No. 10-2013-0095844, filed on Aug. 13, 2013, the entire contents of which is incorporated herein for all purposes by this reference.

### BACKGROUND OF THE INVENTION

1. Field of the Invention

The present disclosure relates to Cr—Mo alloy steel compositions having improved resistance to hydrogen brittleness and methods for heat treating same. More particularly, it relates to Cr—Mo alloy steel compositions, wherein resistance to hydrogen brittleness is improved by inclusion of aluminum, and methods for heat treating same.

2. Description of Related Art

Recently, hydrogen has been hailed as a potential energy source in answer to environmental problems as well as price soaring and depletion of fossil fuel. This is because fossil fuel is the main cause of atmospheric pollution from material discharge and contributes to global warming whereas hydrogen does not discharge pollutants, is environmentally-friendly, and has the merit of utility in almost all present energy systems, such as hydrogen vehicles, hydrogen aircrafts, fuel cells, etc.

However, since hydrogen exists in a gaseous state at room temperature and under atmospheric pressure, its energy density per volume is low and its transport and storage is inconvenient. In particular, development of hydrogen storage containers and piping systems which are light-weight and have other improved physical properties for safe containment of hydrogen is necessary for mass production of hydrogen vehicles or hydrogen fuel cell vehicles.

Conventional Cr—Mo alloy steel composition are mainly used in field applications requiring high tension, high intensity, etc. In particular, alloy steel compositions are largely used for mechanical structures, automobiles or aircrafts. Alloy steel compositions generally have a high yield strength of 830 MPa or higher, a tensile strength of 980 MPa or higher and an elongation property of approximately 10%.

However, since alloy steel compositions generally have high intensity and poor resistance to hydrogen brittleness which is often characteristic of steels having a body-centered cubic lattice (BCC) structure, they have limited application to hydrogen fuel cell vehicles including a hydrogen storage container configured to store hydrogen, or hydrogen piping systems, etc.

Korean Paten Publication No. 1997-0021348 discloses a spring steel having excellent hydrogen brittleness resistance and fatigue property. However, the publication is mainly based on improvement of physical properties such as high stressing of a spring steel rather than improved resistance to hydrogen brittleness.

Therefore, the present inventors aimed to develop a Cr—Mo alloy steel composition having excellent hydrogen brittleness resistance and a method for heat treatment of the same, which can be applied to hydrogen vehicles or hydrogen fuel cell vehicles, etc. with improved yield strength, tensile strength, etc.

The information disclosed in this Background of the Invention section is only for enhancement of understanding of the general background of the invention and should not be taken as an acknowledgement or any form of suggestion that this information constitutes prior art to the presently claimed invention.

### BRIEF SUMMARY

Various aspects of the present invention are directed to providing alloy steel acompositions having improved resistance to hydrogen brittleness and improved economic efficiency as compared with conventional stainless steel, and methods for heat treatment of same, characterized in that the alloy steel compositions are applicable to hydrogen storage containers, piping systems, etc. of hydrogen fuel cell vehicles. Alloy steel compositions of the invention include chromium (Cr), molybdenum (Mo), and aluminum (Al) and demonstrate improved resistance to hydrogen brittleness by stabilizing the inside of the alloy steel compositions and forming an Al₂O₃ layer on the compositions' surface.

An aspect of the present invention provides an alloy steel composition having improved resistance to hydrogen brittleness and methods for heat treatment of the same, characterized in that it includes about 1.0 to about 2.5% by weight of aluminum (Al), based on the total weight of the alloy steel composition.

In some embodiments, the alloy steel compositions of the invention include carbon (C) at about 0.37 to about 0.44% by weight, manganese (Mn) at about 0.55 to 0.90% by weight, silicon (Si) at about 0.15 to 0.35% by weight, chromium (Cr) at about 0.85 to 1.25% by weight, and molybdenum (Mo) at about 0.15 to 0.30% by weight.

In some embodiments, the alloy steel compositions of the invention further include phosphorus (P) of about 0.03% by weight or less, sulfur (S) at about 0.03% by weight or less, copper (Cu) at about 0.50% by weight or less, nickel (Ni) at about 0.25% by weight or less, and the balance of the composition being iron (Fe).

Additionally, methods for heat treating the alloy steel composition are provided herein. In some embodiments, these methods are characterized by including a first step of melting the alloy steel composition described herein; a second step of hot rolling the melted composition; a third step of normalizing the hot rolled composition; a fourth step of air cooling the normalized composition at room temperature; a fifth step of normalizing the air cooled composition; a sixth step of quenching the normalized composition; and a seventh step of tempering the quenched composition.

In some preferred embodiments, the second step of hot rolling is performed on a material of 1.0 to 2.0 mm in thickness at approximately 1,000 to 1,100° C.

In some preferred embodiments, the third step of normalizing is performed for about an hour and 30 minutes to two hours and 30 minutes at approximately 1,000 to 1,200° C.

Additionally, in some preferred embodiments, the fifth step of normalizing is performed for about 20 minutes to 40 minutes at approximately 950 to 1,150° C.

Furthermore, in some preferred embodiments, the seventh step of tempering is performed for about an hour and 30 minutes to two hours and 30 minutes at approximately 520 to 620° C.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is an image taken of a surface of an alloy steel composition according to an exemplary embodiment of the present invention using an optical microscope.

FIG. 2 is an image taken of the surface of the alloy steel composition according to an exemplary embodiment of the present invention using an electronic microscope.

FIG. 3 is a graph showing mole fractions of a body-centered cubic lattice (BCC) and a face centered cubic lattice (FCC) in accordance with the temperature of the composition.

FIG. 4 is a graph showing the results of tension test in an exemplary embodiment of the present invention and a comparative embodiment.

FIG. 5 is an image showing a fracture of a composition according to a comparative embodiment.

FIG. 6 is an image showing a fracture of a composition according to a comparative embodiment into which hydrogen is injected.

FIG. 7 is an image showing a fracture of a composition according to an exemplary embodiment of the present invention.

FIG. 8 is an image showing a fracture of a composition according to an exemplary embodiment of the present invention into which hydrogen is injected.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF EXEMPLARY EMBODIMENTS

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, exemplary embodiments of the present invention will be described in detail. However, the present invention is not limited to the embodiments disclosed below, but can be implemented in various forms. The following embodiments are described in order to enable those of ordinary skill in the art to embody and practice the present invention.

The terminology used herein is for the purpose of describing particular embodiments only and is not intended to be limiting of exemplary embodiments. The singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, components and/or groups thereof, but do not preclude the presence or addition of one or more other features, integers, steps, operations, elements, components and/or groups thereof.

With reference to the appended drawings, exemplary embodiments of the present invention will be described in detail below. To aid in understanding the present invention, like numbers refer to like elements throughout the description of the figures, and the description of the same elements will be not reiterated.

While the invention has been shown and described with reference to certain exemplary embodiments thereof, it will be understood by those skilled in the art that various changes in form and details may be made therein without departing from the spirit and scope of the invention as defined by the appended claims.

The present invention relates to Cr—Mo alloy steel compositions having improved resistance to hydrogen brittleness, and methods for heat treating same. More particularly, it relates to Cr—Mo alloy steel compositions having improved resistance to hydrogen brittleness, wherein the compositions include aluminum (Al), and methods for heat treating same.

The Cr—Mo alloy steel composition according to an exemplary embodiment of the present invention refers to a composition which includes chromium (Cr) and molybdenum (Mo). In some embodiments, the alloy steel composition of the present invention further includes carbon (C), manganese (Mn), silicon (Si), chromium (Cr), and molybdenum (Mo).

While conventional Cr—Mo alloy steel compositions might exhibit good mechanical properties, and thus find application in a high pressure container, a structural material for aircrafts, an automobile axle, etc., they have poor resistance to hydrogen brittleness. In other words, when the composition is exposed to hydrogen or hydrogen is injected to the composition, bond energy of the alloy steel composition will deteriorate, causing a sudden increase in brittleness. As a result, the use of the composition is limited in the presence of hydrogen.

Accordingly, in order to improve resistance to hydrogen brittleness, the Cr—Mo alloy steel compositions of the present invention are characterized by including about 1.0 to 2.5% by weight of aluminum (Al), based on the total weight of the composition.

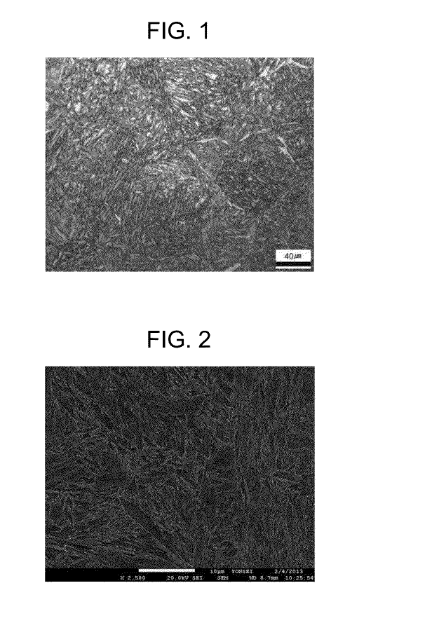

Additionally, in some preferred embodiments, the alloy steel composition includes carbon (C) at about 0.37 to 0.44% by weight, manganese (Mn) at about 0.55 to 0.90% by weight, silicon (Si) at about 0.15 to 0.35% by weight, chromium (Cr) at about 0.85 to 1.25% by weight, and molybdenum (Mo) at about 0.15 to 0.30% by weight. Additionally, in some preferred embodiments, the alloy steel composition includes phosphorus (P) at about 0.03% by weight or less, sulfur (S) at about 0.03% by weight or less, copper (Cu) at about 0.50% by weight or less, and nickel (Ni) at about 0.25% by weight or less. For reference, FIG. 1 is an image taken of a surface of a composition according to an exemplary embodiment of the present invention using an optical microscope, and FIG. 2 is an image taken of the surface of the composition according to an exemplary embodiment of the present invention using an electronic microscope.

Hereinafter, components of the alloy steel composition and their contents will be described in further detail.

Components of alloy steel composition and contents thereof

Aluminum (Al)

Aluminum (Al) serves to disperse stress generated by an external force and the like which are applied to the alloy steel composition, and improve resistance to hydrogen brittleness of the composition by ensuring stability of austenite. Additionally, the alloy steel composition including aluminum (Al) has an Al₂O₃ layer formed on a surface thereof, and thus reduces penetration of hydrogen flowing in from the outside of the alloy steel composition, which results in improved resistance to hydrogen brittleness of the alloy steel composition.

In some embodiments, the aluminum (Al) is present in an amount of about 1.0 to 2.5% by weight, based on the total weight of the composition. More preferably, the aluminum (Al) is present in an amount of about 1.4% by weight. At aluminum (Al) content of less than 1.0% by weight, it is difficult to ensure sufficient resistance to hydrogen brittleness of the alloy steel composition, whereas aluminum (Al) content exceeding 2.5% by weight results in deterioration in mass productivity and physical properties of the alloy steel composition. At aluminum (Al) content exceeding 5% by weight, aluminum (Al) may act as a stabilization element and becomes a combined phase by producing ferrite in addition to an austenite single phase at a high hardening temperature. Since the combined phase cannot have a tempered martensite single phase after heat treatments such as quenching, tempering, etc., the composition can lose its high hardness and rigidity that may be obtained through tempered martensite, and moreover, trapping phenomenon might occur owing to interphase interface, which has an adverse effect on hydrogen brittleness.

Additionally, the effects of aluminum (Al) content at about 1.4% by weight in the composition of the present invention were confirmed through a simulation program (J. Mat. Pro) used to generate an equilibrium state diagram of the alloy steel.

Carbon (C)

As an element for reinforcing a matrix, carbon (C) serves to ensure sufficient tensile strength of an alloy steel composition after quenching and tempering. In the context of the present invention, carbon (C) is present in some embodiments at about 0.37 to 0.44% by weight, based on the total weight of the composition. More preferably, carbon (C) is present at about 0.38% by weight. Carbon (C) content at less than 1.0% by weight may make it difficult to ensure sufficient tensile strength, etc. after quenching and tempering, whereas when carbon (C) content exceeding 0.44% by weight leads to a deterioration in anti-corrosiveness and toughness of the composition. When a composition including excessive carbon (C) content is applied to a high pressure container, etc., toughness of the high pressure container will be insufficient, causing damage to the high pressure container.

Manganese (Mn)

Manganese (Mn) is solubilized in a solid phase in a composition to improve bending fatigue strength of the composition and aid in generation of pearlite. Additionally, manganese (Mn) reacts actively in improving hardenability. In the context of the present invention, manganese (Mn) is included in some embodiments at about 0.55 to 0.90% by weight, based on the total weight of the composition. More preferably, manganese (Mn) is present at about 0.64% by weight. Manganese (Mn) content of less than 0.55% by weight may make it difficult to improve sufficient bending fatigue strength and hardenability whereas manganese (Mn) content exceeding 0.90% by weight increases excessive hardenability will increase excessively, thereby generating not only an undercooled tissue which is a fracture starting point of the composition but also forming manganese sulfide (MnS) serving to inhibit hydrogen brittleness resistance.

Silicon (Si)

Silicon (Si) serves as an element for reinforcing solid solutions to improve rigidity of an alloy steel composition. In the context of the present invention, silicon (Si) is present in some embodiments at about 0.15 to 0.35% by weight, based on the total weight of the composition. More preferably, silicon (Si) is present at about 0.20% by weight. Silicon (Si) content at less than 0.15% by weight may make it difficult to ensure sufficient rigidity of the composition, whereas silicon (Si) content exceeding 0.35% by weight leads to insufficient dissolution of carbonates for the alloy steel composition. Accordingly, more heat may be required in order to convert the composition into austenite, therefore the rigidity of the alloy steel composition may be deteriorated with de-carbonization of the surface of the alloy steel composition due to a high temperature.

Phosphorus (P)

Phosphorus (P) is an ingredient which can be added to enhance rigidity of an alloy steel composition. In the context of the present invention, phosphorus (P) is present at about 0.03% by weight or less, based on the total weight of the composition. Phosphorus (P) content exceeding 0.03% by weight, however, leads to deterioration in toughness, hydrogen brittleness resistance, etc. of the alloy steel composition.

Sulfur (S)

Sulfur (S) is an ingredient which can be added to enhance hydrogen brittleness resistance, etc. of an alloy steel composition. In the context of the present invention, sulfur (S) is present in some embodiments at about 0.03% by weight or less, based on the total weight of the composition. Silicon (Si) content exceeding 0.03% by weight affects brittleness of grain boundary, thereby causing degradation of toughness, hydrogen brittleness resistance, etc. of the composition.

Chromium (Cr)

Chromium (Cr) serves to enhance anti-corrosiveness and hardenability of an alloy steel composition. In the context of the present invention, chromium (Cr) is present at about 0.85 to 1.25% by weight, based on the total weight of the composition. More preferably, chromium (Cr) is present at about 1.05% by weight. Chromium (Cr) content at less than 0.85% by weight may make it difficult to ensure sufficient anti-corrosiveness and hardenability of the composition, whereas chromium (Cr) content exceeding 1.25% by weight leads to deterioration in rigidity, hardness, etc. of the alloy steel composition since carbides cannot be dissolved easily during quenching.

Molybdenum (Mo)

Molybdenum (Mo) serves to enhance hardenability of an alloy steel composition, improve hydrogen brittleness resistance by reinforcing rigidity of grain boundary and enhance anti-corrosiveness of the composition through adsorption of molybdate ions that are generated upon corrosive dissolution. In the context of the present invention, molybdenum (Mo) is present in some embodiments at about 0.15 to 0.30% by weight, based on the total weight of the composition. More preferably, molybdenum (Mo) is present at about 0.26% by weight. Molybdenum (Mo) content of less than 0.15% by weight may lead to deterioration in hardenability, hydrogen brittleness resistance, anti-corrosiveness, etc. of the alloy steel composition whereas molybdenum (Mo) content exceeding 0.30% by weight results in decreased economic efficiency through saturation of such performances.

Copper (Cu)

Copper (Cu) serves to enhance anti-corrosiveness of an alloy steel composition. In the context of the present invention, copper (Cu) is present in some embodiments at about 0.50% by weight or less, based on the total weight of the composition. More preferably, copper (Cu) is present at about 0.49% by weight. Copper (Cu) content exceeding 0.50% by weight may lead to decreased economic efficiency through saturation of the anti-corrosiveness and the probability of causing brittleness to alloy steel composition through hot rolling may also increase.

Nickel (Ni)

Nickel (Ni) is an ingredient which can be added to enhance anti-corrosiveness and tensile strength of an alloy steel composition and improve toughness of the alloy steel composition after quenching and tempering. In the context of the present invention, nickel (Ni) is present at about 0.25% by weight or less, based on the total weight of the composition. Nickel (Ni) content exceeding 0.25% by weight may lead ton excessively high hardenability, which may cause deterioration in physical properties of the composition through production of undercooled tissues.

Usage

Alloy steel composition with excellent hydrogen brittleness resistance according to an exemplary embodiment of the present invention can be applied to where the composition is exposed to hydrogen and excellent physical properties is required. Hence, the composition may be applied to a container for storing hydrogen or in a piping, some part of which is in contact with hydrogen. In preferred embodiments, the composition is applied to a hydrogen storage container for hydrogen aircrafts, hydrogen vehicles or hydrogen fuel cell vehicles or a piping for conveying hydrogen.

Method for Heat Treatment

Hereinafter, another aspect of the present invention relates methods for heat treating the alloy steel compositions of the present invention.

More particularly, it is preferable for the method for heat treatment to include the steps of: the first step of melting the alloy steel composition according to an exemplary embodiment of the present invention, the second step of hot rolling the melted composition, the third step of normalizing the hot rolled composition, the fourth step of air cooling the normalized composition to room temperature, the fifth step of normalizing the air cooled composition, the sixth step of quenching the normalized composition, and the seventh step of tempering the quenched composition.

It is preferable for the second step of hot rolling to be performed with a thickness of approximately 1.0 to 2.0 mm at approximately 1,000 to 1,100° C., however it is more preferable for the second step of hot rolling to be performed with a thickness of approximately 1.5 mm.

Additionally, it is preferable for the third step of normalizing to be performed for an hour and 30 minutes to two hours and 30 minutes at approximately 1,000 to 1,200° C., however it is more preferable for the third step of normalizing to be performed for about two hours at approximately 1,100° C.

Additionally, it is preferable for the fifth step of normalizing to be performed for 20 minutes to 40 minutes at approximately 950 to 1,150° C., however it is more preferable for the fifth step of normalizing to be performed for about 30 minutes hours at approximately 1,050° C.

Additionally, it is preferable for the seventh step of tempering to be performed for an hour and 30 minutes to two hours and 30 minutes at approximately 520 to 620° C., however it is more preferable for the seventh step of tempering to be performed for about two hours at approximately 570° C.

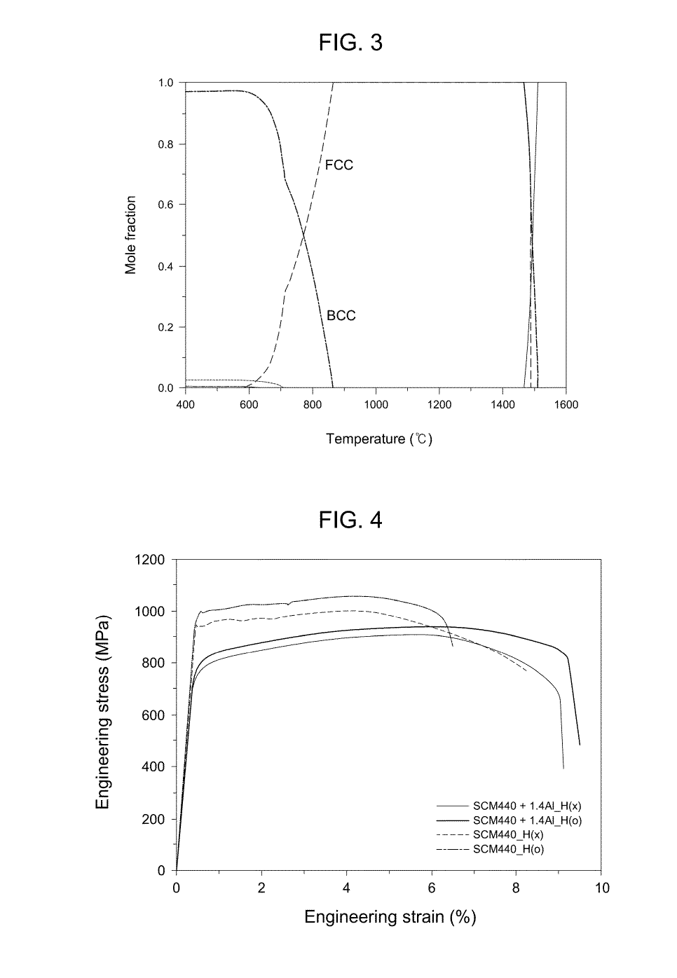

FIG. 3 is a graph showing mole fractions of a body-centered cubic lattice (BCC) and a face centered cubic lattice (FCC) in accordance with the temperature of a composition. At this time, the composition may be converted from a body-centered cubic lattice (BCC) austenite into a face centered cubic lattice (FCC) austenite through normalizing at approximately 1,100° C. and 1,000° C. and through quenching in the sixth step, the austenite may be converted into martensite, wherein the austenite is oversaturated with carbon. However, the martensite has very high hardness and rigidity, causing relatively high brittleness of the composition. Therefore, it is preferable to alleviate excessive hardness, rigidity, etc. of the composition and enhance flexibility, toughness, etc. by converting some of martensite into cementite through the tempering of the seventh step in which the composition is heated at a proper temperature.

### EMBODIMENTS

Hereinafter, the present invention will be described in further detail with reference to the following embodiments. However, it should be understood that detailed description provided herein is merely intended to provide a better understanding of the present invention, but is not intended to limit the scope of the present invention.

In order to check physical properties of the alloy steel composition of the present invention, the results of tensile test are arranged in the following graph of FIG. 4, after the alloy steel compositions of exemplary embodiments and comparative embodiments including the components and contents were prepared as shown in the following Table 1.

TABLE 1

| Description | Unit | Al | C | Mn | Si | Cr | Mo | Cu | Fe | Total |
|---|---|---|---|---|---|---|---|---|---|---|
| Exemplary | % by | 1.4 | 0.38 | 0.64 | 0.20 | 1.05 | 0.26 | 0.49 | Balance | 100 |
| Embodiments | weight | | | | | | | | | |
| Comparative | % by | — | 0.38 | 0.64 | 0.20 | 1.05 | 0.26 | 0.49 | Balance | 100 |
| Embodiments | weight | | | | | | | | | |

Table 1 is a table showing the components and contents of exemplary embodiments and comparative embodiments. The difference between exemplary embodiments and comparative embodiments is the presence of aluminum (Al). That is, exemplary embodiments include aluminum (Al) to show excellent hydrogen brittleness resistance, whereas comparative embodiments do not include aluminum (Al) to show inferior hydrogen brittleness resistance.

The Cr—Mo alloy steel compositions used in the exemplary embodiments and the comparative embodiments is also referred to as SCMs, and such SCMs can be classified into SCM415, SCM418, SCM420, SCM421, SCM430, SCM432, SCM440, etc., depending on the components and contents of chromium (Cr), molybdenum (Mo), etc. In the exemplary embodiments and the comparative embodiments, SCM440 was used, but another kind of SCM could be used.

FIG. 4 is a graph showing the results of tension test in an exemplary embodiment and a comparative embodiment. That is, in the graph, engineering strain to engineering stress in an exemplary embodiment and a comparative embodiment is compared. In the drawing SCM440 means a comparative embodiment with no aluminum (Al), whereas SCM440+1.4Al means an exemplary embodiment where SCM440 further includes aluminum (Al) at 1.4% by weight. Additionally, H(0) means that hydrogen is injected, and H(X) means that hydrogen is not injected.

More specifically, in tension test of the exemplary embodiment and the comparative embodiment, hydrogen was injected electro-chemically in a 3% NaCl+0.3% NH₄SCN solution at a current density of 50 A/m² for 48 hours after manufacturing and processing the exemplary embodiment and the comparative embodiment for injecting hydrogen in a size less than the ASTM E 8M-04 standard (sub-size) in parallel with a direction of rolling. When the hydrogen injection is completed, yield strength, tensile strength and elongation rate were measured for the exemplary embodiment and the comparative embodiment through a slow strain rate test at a constant transformation speed of 1 mm/min. As for the slow strain rate test, the exemplary embodiment and the comparative embodiment performing no hydrogen injection were experimented in the same method, and the results were then compared as well.

In the drawing, it was proved that the SCM440+H(O) of the comparative embodiment with hydrogen injection was fractured easily compared to the SCM440+H(X) of the exemplary embodiment without hydrogen injection from the fact that engineering transformation rate was smaller. That is, it was found that hydrogen brittleness of the comparative embodiment is great due to hydrogen injected into the comparative embodiment.

On the other hand, it was known that the SCM440+1.4Al+H(O) of the exemplary embodiment with hydrogen injection was not fractured easily compared to the SCM440+1.4Al+H(X) of the exemplary embodiment without hydrogen injection from the fact that its engineering transformation rate was high. That is, it was found that hydrogen injected into the exemplary embodiment could not affect hydrogen brittleness since hydrogen brittleness resistance of the exemplary embodiment was excellent.

In the exemplary embodiment including aluminum (Al), engineering stress was slightly reduced compared with the comparative embodiment, but it was proved that hydrogen brittleness against injected hydrogen was not found substantially. It indicates that hydrogen brittleness resistance of the exemplary embodiment was improved compared with the comparative embodiment.

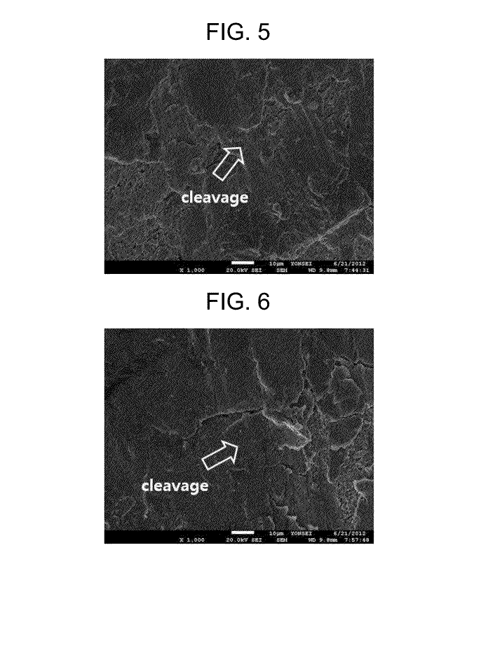

Additionally, FIG. 5 is an image showing a fracture of a comparative embodiment and FIG. 6 is an image showing a fracture of a comparative embodiment into which hydrogen is injected. The fractures of FIGS. 5 and 6 show cleavages caused owing to brittle factures.

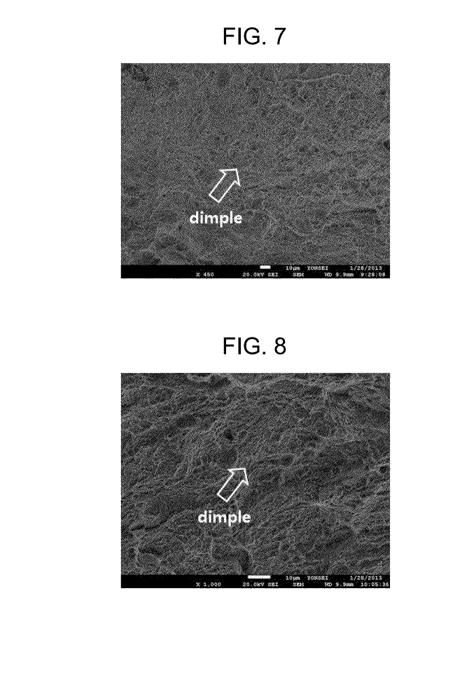

On the other hand, FIG. 7 is an image showing a fracture of an exemplary embodiment and FIG. 8 is an image showing a fracture of an exemplary embodiment into which hydrogen is injected. The fractures of FIGS. 7 and 8 show dimples which are ductile fractures rather than the brittle fractures.

Accordingly, the exemplary embodiments including aluminum were not affected by hydrogen substantially, and showed the ductile fractures rather than the brittle fractures, thus it could be seen that hydrogen brittleness resistance of the exemplary embodiments according to an exemplary embodiment of the present invention was improved compared with the exemplary embodiments having no aluminum.

The present invention has effects of improving hydrogen brittleness resistance while maintaining constant yield strength and tensile strength since the Cr—Mo alloy steel composition further includes aluminum (Al).

Additionally, the alloy steel composition according to an exemplary embodiment of the present invention has an advantage of superior cost efficiency when the Cr—Mo alloy steel composition is applicable to a hydrogen storage container for hydrogen fuel cell vehicles, pipings, etc. using the excellent hydrogen brittleness resistance of the Cr—Mo alloy steel composition according to an exemplary embodiment of the present invention.

While the invention has been shown and described with reference to certain exemplary embodiments thereof, it will be understood by those skilled in the art that various changes in form and details may be made therein without departing from the spirit and scope of the invention as defined by the appended claims.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An alloy steel composition comprising iron, carbon, chromium, molybdenum, and about 1.0 to 2.5% by weight of aluminum (Al), based on the total composition weight of the alloy steel composition.

2. The alloy steel composition according to claim 1, wherein the alloy steel composition comprises carbon (C) at about 0.37 to 0.44% by weight, chromium (Cr) at about 0.85 to 1.25% by weight, molybdenum (Mo) at about 0.15 to 0.30% by weight, and further comprises manganese (Mn) at about 0.55 to 0.90% by weight, and silicon (Si) at about 0.15 to 0.35% by weight.

3. The alloy steel composition according to claim 2, further comprising phosphorus (P) at about 0.03% by weight or less, sulfur (S) at about 0.03% by weight or less, copper (Cu) at about 0.50% by weight or less, nickel (Ni) at about 0.25% by weight or less and the balance of the composition being iron (Fe).

4. A method for heat treating an alloy steel composition, said method comprising the steps of:
1) melting the alloy steel composition of claim 1;
2) hot rolling the melted composition produced by step 1);
3) normalizing the hot rolled composition produced by step 2);
4) air cooling the normalized composition produced by step 3) to room temperature;
5) normalizing the air cooled composition produced by step 4);
6) quenching the normalized composition produced by step 5); and
7) tempering the quenched composition produced by step 6).

5. The method according to claim 4, wherein the step of hot rolling is performed with the melted composition at thickness of about 1.0 to 2.0 mm at approximately 1,000 to 1,100° C.

6. The method according to claim 4, wherein step 3) of normalizing is performed for about an hour and 30 minutes to two hours and 30 minutes at approximately 1,000 to 1,200° C.

7. The method according to claim 4, wherein step 5) of normalizing is performed for about 20 minutes to 40 minutes at approximately 950 to 1,150° C.

8. The method according to claim 4, wherein step 5) of normalizing is performed for an hour and 30 minutes to two hours and 30 minutes at approximately 520 to 620° C.
